(19) United States
(12) Patent Application Publication
(10) Pub. No.: US 2006/0156409 A1
(43) Pub. Date: Jul. 13, 2006

(54) System and method for subscription broadcast medium delivered over a broadband network

(76) Inventor: James Chladek, New York, NY (US)

Correspondence Address: KATTEN MUCHIN ROSENMAN LLP, 575 MADISON AVENUE, NEW YORK, NY, 10022-2585, US

(21) Appl. No.: 10/510,191

(22) PCT Filed: Apr. 2, 2003
(86) PCT No.: PCT/US03/10016

§ 371 Date: Jul. 21, 2005

Related U.S. Application Data
(60) Provisional application No. 60/369,302, filed on Apr. 2, 2002.

(51) Int. Cl. H04N 7/16

(52) U.S. Cl. 726/26

(57) ABSTRACT

A broadcast medium distribution system (100) provides for delivery of broadcast media over a large number of possible content channels over a broadband network (40) to a television or other display device via a player (20). Audio and graphical still frame program content are produced by a producer (30) and delivered over the broadband network (40) to a network server (10) for scheduled streaming to players (20). Each player (20) is provided with a unique and unchangeable identifier so that broadcast media may be securely delivered to players (20) on an individualized subscription basis.

### CROSS-REFERENCE TO RELATED APPLICATION

The present application claims priority under 35 U.S.C. § 119(e) from U.S. Ser. No. 60/369,302, filed on Apr. 2, 2002. U.S. Ser. No. 60/369,302 was filed by an inventor common to the present application, and is hereby incorporated by reference.

### FIELD OF THE INVENTION

The present invention relates to a system and method for distributing a broadcast medium by subscription over a broadband network. In particular, it relates to streaming of audio and graphical still frames in a synchronized manner for playback.

### BACKGROUND OF THE INVENTION

While the development of the cable television industry has expanded the number and types of programming available to consumers, many other enterprises could benefit from having a means for distributing information via a broadcast medium. For example, news media, educational institutions and retail suppliers would benefit by having a means for providing information today delivered primarily in print media, and particularly in mailings, alternatively in a broadcast form suitable for receipt over a television or similar display device in a household. Such media delivered today in print form could be easily displayed by audio and/or graphical still image means.

It would also be advantageous id such media could be delivered in a secure manner to an authorized set of subscribers.

### SUMMARY OF THE INVENTION

The present invention provides a system for distributing broadcast media program content to one or more display devices on a subscription basis. The system includes a server for receiving authored program content, for storing the received content, for scheduling delivery of the stored content at one or more predetermined times, and for delivering the stored content to one or more subscribers over at least one broadband network at the one or more predetermined times. The system also includes a player for initiating a subscription for delivery of the stored content, for receiving the stored content, and for providing the stored content to the one or more display devices.

The player further includes setup means for connecting to and logging in to the at least one broadband network, menu means for displaying subscriptions channels, and interaction means for selecting a feature indicated by the delivered content. In a preferred embodiment, the system further includes a producer for authoring stored content and providing the authored content to the server in a predetermined format.

### DESCRIPTION OF THE DRAWING

A more complete understanding of the inventions maybe obtained by reading the following description of the specific illustrative embodiments of the invention in conjunction with the appended drawing in which:

FIG. 1 provides a general schematic drawing of an embodiment of the present inventions;

FIG. 2 illustrates elements of a menu screen associated with a player portrayed in FIG. 1;

FIG. 3 illustrates features of a remote control to be used in conjunction with the player of FIG. 1, and

FIGS. 4a, b respectively illustrate front and rear panel features of the player of FIG. 1.

### DETAILED DESCRIPTION

The following detailed description includes a description of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

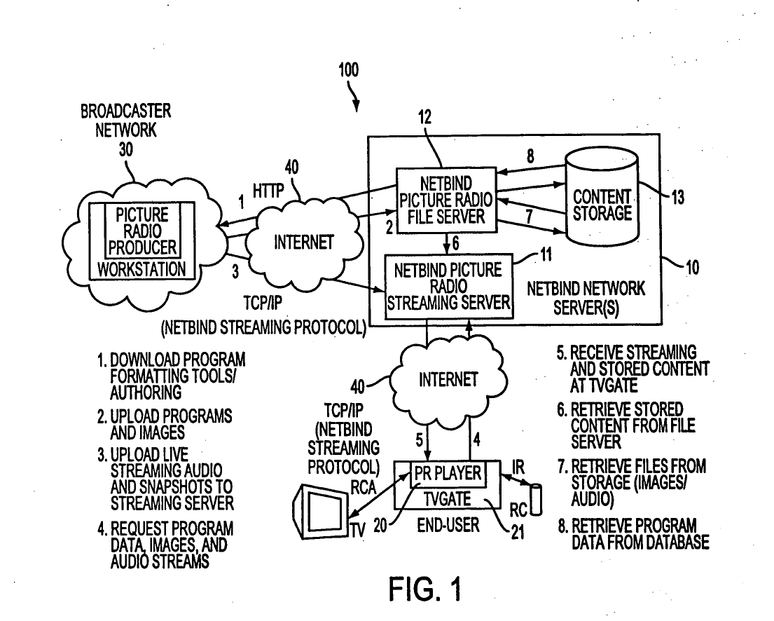

Applicant discloses a turnkey platform designed to provide an interactive content session between an end-user's set-top-box/gateway and an information program content provider (for example, such as a broadcast radio or television network), using any type of dialup or broadband access network. The platform is designed to allow access to a large number of content channels, provided by potentially by a broad variety of types of content providers (for example, including publishers, print sources, educational institutions, and broadcast radio and television networks). The application may be delivered over the Internet, for example, to a specialized customer premises equipment (CPE), referred to herein as the Set-Top-Box/Gateway (TVGATE). The TVGATE is designed to be easily installed, configured and used. FIG. 1 presents a functional architecture and a call flow for the various fundamental parts of the platform application, which is described in greater detail herein.

The application relates to the broadcast and entertainment industry. Content providers are envisioned to include a large variety of media sources, for example, such as Bloomberg Radio, Newsweek, Bloomingdales, Fashion Network, Home Shopping Network, Martha Stewart Living, and others. It supports a variety of types of media content, such as magazine pages, news headlines, and advertising of products in the form of image, text and audio. Also, support for video streaming may be provided in association with live content. In the TVGATE, users are provided with a simple, intuitive interface that allows for easy content selection in a manner somewhat analogous to conventional cable TV channel and Internet browser “favorites” selection.

As shown in FIG. 1, principal architectural components in the application 100 architecture include the Server 10, the Player 20, the Producer 30 and a supporting backbone network 40.

The Server 10 is responsible for providing services to the Producer 30 (Broadcaster's workstation) and the Player 20 (end-users' TVGATE 21) components. For the Producer 30, it provides facilities for receiving streaming audio broadcasts, graphical still frames, and frame scheduling and formatting directives. A collection of frames with scheduling and formatting is considered a Program within the application, and the server 10 allows for storing, retrieving, and updating these programs. For the Player 20, the Server 10 provides facilities for distributing the content (for example, streaming audio together with graphical still frames) in a synchronized manner for playback. In addition, the Server 10 provides facilities for distributing associated Program formatting and scheduling information. The Server 10 may be implemented as a series of software programs running on conventional high-performance computer server hardware.

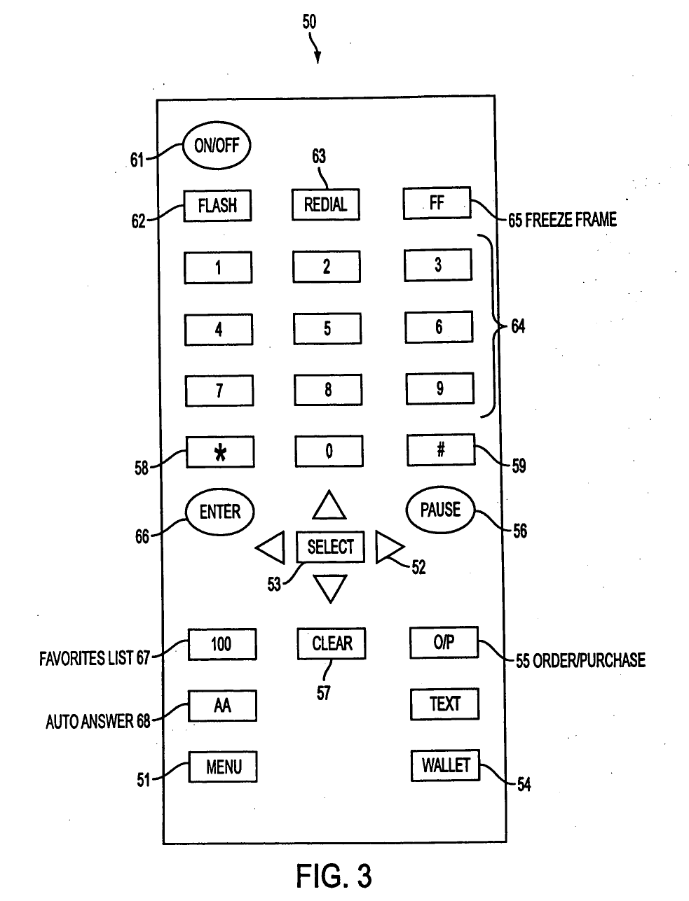

The Player 20 component resides in the TVGATE 21 and is responsible for playing the streaming audio content, displaying the graphical channel content, and handling interaction with the end-user. The end-user provides input to the TVGATE 21, for example, using an infrared universal remote control, or alternatively, a specialized remote control such as is illustrated by FIG. 3. The Player 20 provides support for user authentication, channel selection and retrievable directories of favorite channels or programs. The Player 20 may be implemented as a series of software programs running on the TVGATE 21, which is a specialized gateway device that may be utilized for the purposes of connecting with a telephone and/or broadband network, providing information to the telephone and/or broadband information network in a form/format suitable for transmission over the network, and receiving and decoding information from the telephone and broadband network for display on a graphical display device (for example, on a conventional NSTC or HDTV TV or monitor). A suitable TVGATE 21 is produced, for example, by NetBind, Inc.

The Producer 30 may be implemented as a series of software programs installed by the content providers (for example, radio and/or TV broadcasters) on conventional computer workstations, for use in preparing Programs for their associated Channels. The Producer 30 interacts with the Server 10 to submit Programs and specify scheduling. Program content may include, for example, stored still frames, streaming audio and live still frames. The Producer 30 further includes authoring tools to assist content providers to create new programs, edit or delete existing programs, and schedule those programs for broadcast. Programs can be configured to combine live or prerecorded audio, live or prerecorded still frame pictures (camera shots or prepared graphics), and text overlays, in a series of segments called Frames. Content providers may provide live content, for example, using specialized software programs installed on the TVGATE 21 appliance for receiving video and audio streams and transforming this information into a form suitable for transmission over the backbone network. Alternatively, content providers may use conventional broadcast systems for producing video and audio streams in a suitable form for transfer.

The Backbone Network 40 is designed to provide support for content distribution, and may include, for example, portions of the public telephone network (PSTN) and the Internet. Each participating entity is assigned a unique ID, facilitating for example Internet connection made using secure virtual private network (VPN) technology via third-party Internet service providers (ISPs). Alternatively, connection may be made using, for example, 800 service PSTN facilities directed to one or more third party service providers. In either case, users and content providers are provided with a secure communications environment that is resistant, for example, to attack from viruses, hackers and the like. This environment is ideal for supporting associated e-commerce services. By using conventional, commercial network facilities, network obsolescence is avoided.

Software components of the player 20 may be installed in the TVGATE 21 through a pre-provisioning process. Alternatively, these components may be downloaded to the TVGATE 21 over a broadband network or the Internet.

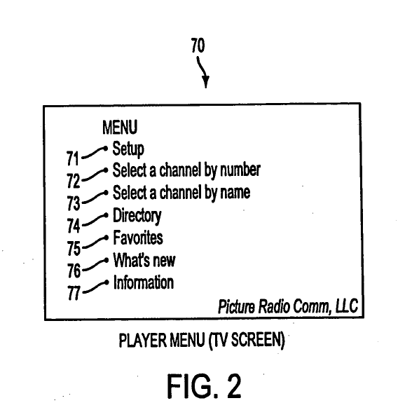

The Player 20 provides the user with a graphical user interface (GUI) for initiating the connection to the network, displaying the channel content, and handling user inputs (see, for example, the sample menu screen of FIG. 2). User input may be provided through a universal remote control, or alternatively through a specialized remote control (see FIG. 3) that communicates with the TVGATE 21 via an infrared port on the appliance.

A main menu of the Player 20 GUI may be accessed, for example, by using the followed by the Menu button 51 on the universal remote control 50.

Upon making a physical network connection(s) and powering up the TVGATE 21, the TVGATE 21 automatically senses the network ports to determine the type of network connection, and proceeds to establish required protocols with the connecting network(s). As previously noted, for secure communications, it is anticipated that network connections will include 800 service on the PSTN, and secure VPN services over the Internet provided by third-party ISPs.

Principal main menu items for the Player 20 GUI are described individually below, and are shown as selectable menu items in menu 70 of FIG. 2. Each may be selected, for example, by use of arrow keys 52 select button 53 on remote control 50:
Setup (71)—This selection leads into the Setup screen, where the user can login with a user name and password. In a preferred embodiment of the present invention, the user will also be able to change account information, choose connection information, change local access arrangements (DSL vs. Cable broadband access) and request the unit to reconnect if necessary.
Select a Channel by Number (72)—This selection allows the user to access a channel by entering the channel's numeric code advertised by the broadcaster or content provider (for example, by entering “#888-345-5788 “for QVC's shopping channel). For ease of use, the ”#” button may alternatively be used as an action trigger function to move to a screen with a prompt to enter the associated code or number. If the number entered does not correspond to an existing channel, then a message is displayed to the user and they are given the option to search an associated directory (see Directory selection below). If the user has not subscribed to the specific channel, a screen provided by the Producer of the channel describing how to subscribe will be displayed. If the channel is free or the user has subscribed to the channel, then a channel splash screen is displayed, and the transmission of the channel content begins. In a preferred embodiment of the invention, for example, content providers may be assigned “800” series numbers that correspond to “800” series telephone numbers that are recognizably advertising and using (or, alternatively, “888” and “887” series numbers similarly used).
Select a Function (not shown)—In another embodiment of the present invention, users are able to enter a function during content delivery. For example, the content provider may advertise the purchase of a particular product by selecting a particular code (e.g., candles by pressing 222). In this example, by pressing the wallet button 54 or order purchase (O/P) button 55 on the remote control unit, the user will be prompted with a window to enter the digits 222, and then to press Enter to send the request. This would lead the users to an e-commerce environment supported by the advertiser or media producer.
Select a Channel by Name (73)—This selection allows the user to access a channel by entering the channel's name advertised by the broadcaster or content provider (for example, by entering “*QVC” for the QVC channel). The * is used as an action trigger to move to a screen with a prompt to enter the name. If the name entered does not correspond to an existing channel, then a message is displayed to the user and they are given the option to search the directory. If the user has not subscribed to the specific channel, a screen provided by the Producer of the channel describing how to subscribe will be displayed. If the channel is free or the user has subscribed to the channel, then the channel splash screen is displayed, and the transmission of the channel content begins.

Directory (74)—This selection allows the user to access a directory of all supported channels. All channels may be listed alphabetically. The user can scroll through the channels for example by using the (up and down) arrow keys on the universal remote control. When the arrow highlights the desired channel, the user may press the select key on the remote control to switch to the channel. Similar procedures are used for directories organized by number (invoked, for example, by pressing “#”) and by name (invoked, for example, by pressing “*”).

Favorites (75)—This selection leads to the Favorites screen, where the user may enter the number or alphanumeric identifier for a pre-configured favorite channel. The user may replace a channel within the Favorites lists with another available channel. This does not affect the accessibility of the removed channel through other channel selection mechanisms. The list may be maintained by the user through the GUI and remote control, for example, employing an interface similar to ones used to bookmark or store favorites in an Internet browser environment. Initially, users may receive a preprogrammed Favorites list (for example, containing a maximum of 200 entries). The preprogrammed entries may be selectively overwritten by the users with new entries of their preference.
What's New (76)—This selection brings the user to a specialized channel, which may be used, for example, to advertise new features and channels, or upcoming local events. The service may be administered, for example, by a third party service provider. Content for this channel may be streamed to the TVGATE 212 on demand. Over this channel, users may be able, for example, to view advertisements relating to museum exhibits, shows, conferences, and other programs or events.
Information (77)—This selection provides the user with screens, which include contact and other types of relatively static information. Content for this channel may be streamed to the TVGATE on demand and/or stored and periodically updated at the TVGATE on a regular schedule.

Other Service Channels (not shown)—These selections may provide the user with access to “standard” non-subscription channels of general interest (for example, news, weather, time/time zone, and the like). Other features of the TVGATE appliance (for example, NetBind security features) may be provided as selections as well.

When a particular channel has been selected, using one of the methods outlined above, in a preferred embodiment of the present invention, the welcome screen for that channel displays first, and then normal programming for the channel begins. If the channel requires subscription and the user has not subscribed, then a message about how to subscribe is provided, and the user is redirected back to the Select Channel, Directory, or Favorites page, depending on the channel selection method used.

While the regular channel program content is being displayed) the user may have a number of choices for interacting with the content. In a preferred embodiment of the invention, the user has the following options which may be invoked by use of remote control 50 of FIG. 3:
Menu—The user may press the Menu button 51 on the remote control, in which case the Channel program content is halted and the main menu is redisplayed.
Pause—The user may press the Pause button 56, in which case the visual part of the current program pauses, while the audio for the channel continues to play. The user may rejoin the program by pressing pause again. Any visual program content that was scheduled for the time period during which the user had frozen the display may be skipped over.
Repeat—Channel content may be programmed to repeat, allowing the user additional chances to see the content. For example, in a video-on-demand mode, after the user presses the Pause button 56 for a second time, the user will be able to see a continuation of the frame. In a live mode the user may have to wait until the content is cycled for the program to repeat.
Clear—Clear button 57 will allow the user to erase entered numbers or alphanumeric characters in a prompt line/window.
Star (*), Pound (#)—Starbutton 58 and Pound button 59 may be used to prompt the system to create the line or window in which the user may be prompted either to enter a number or the name of a channel, just as they might from the main menu. See the previous section for more information about the feature.
Customer Support—A special command sequence may be reserved to invoke this function. The Player would transmit a customer support request to the content provider with customer ID information, and the content provider could reply to the user according to information transmitted in the ID information and stored by the Player as customer preferences (for example, a telephone number or email address).

Other features of remote control 50 of FIG. 3 may include power button 61, telephone features provided by flash button 62 and redial button 63 (for PSTN interconnections), standard number pad 64, freeze frame button 65, and enter button 66. Favorite channels may be recalled by pressing favorites button 67, and an auto answer feature for answering an incoming network access request can be invoked by pressing auto answer button 68. Text button 69 may be selected to retrieve a text menu to be used in conjunction with arrow buttons 52 and select button 53 in order to enter text responses.

The Producer 30 may be used by a channel content provider to prepare content for distribution on the channel(s). It may be used for uploading program files, images, and audio recordings for storage in the streaming server file system and database. It may also be used to create, edit, and delete programs, and to play back the programs for review purposes.

The Producer 30 may be installed in the channel content provider's studio, where it may be connected to cameras and microphones used to record the live content, and where it provides a content provider interface for program management. The main features of the Producer component are as follows:
Image and Sound repository—Graphical images, including camera snapshots, and audio recordings can be added into the channel content, and uploaded into the Server 10. These files can be referenced by frames within programs, and can be edited or deleted using the interface.
Program Development—Programs can be created, edited, and deleted using the Program Developer functionality of the Producer 30. Programs may be defined as a series of frames, which can contain stored or live images and audio, and text overlays, with simple frame animation abilities.
Program Scheduling—Channel content may be defined as a set of scheduled programs.

The Producer may be used to schedule programs on a daily, weekly, or one-time only basis. Programs may be stored without being scheduled, in which case they do not display on the Channel. Programs may be scheduled to continuously repeat during periods of time.

The Server 10 consists of three principal components (see, for example, FIG. 1).

The Streaming Server 11 is designed to handle distributing channel content to the connected Players 20 (TVGATES 21) and also for receiving live content from the Producers 30.

The File Server 12 (including Program Manager may be a web-based component, which handles interfacing with the PICTURE RADIO Producer component.

Both of these components interact with the content storage 13, in which the channel and program information and image and audio files are stored.

The Streaming Server 11 is responsible for handling the streaming of Channel content to the connected Players 20.

The Streaming Server 11 is designed to receive requests from the Players 20 for channel content, and dispatches the required program frame information. The Players 20 then parse this information and request either stored images or audio or at a later release live feed data from the Streaming Server.

Stored images and other data may be cached on the Player 20 and/or, for example, by an Internet Service Provider (ISP) supporting a plurality of Players 20 (the amount of content cached will depend on the amount of available memory), reducing the amount of data that needs to be directly transmitted.

The Streaming server 11 interfaces with the Content Storage 13 to retrieve the program information, and stored images and audio.

In a preferred embodiment of the invention, live images and audio will be transmitted directly from the Producers 30 to the Streaming Server 11 as they are generated, and the Streaming Server 11 will dispatch this data (on a store-forward basis) to the clients requesting it.

The Program Manager within the File Server 12 will be responsible for interfacing with the PICTURE RADIO Producer. It enables the Producer to upload and download channel content. It handles requests from the Producer to create, modify, or delete programs and schedules. It may use, for example, a standard world-wide-web interface to communicate with the Producer. The communication may be made secure, using, for example, Secure Sockets Layer (SSL) technology with a login procedure required for the Producer, or any of a variety of other means for guaranteeing secure communications.

Content Storage 13 is used to store content provider information, and channel content scheduling and program information. Actual frame formatting information (content, animation, etc.), program layout information, and program scheduling may be stored in the Content Storage 13, to be used by both the Streaming Server 11 and the Program Manager of File Server 12.

The Content Storage 13 may also used to store pre-recorded images and audio for Programs. The Streaming Server may access the Content Storage 13 directly when providing clients with images and audio streams.

The files stored in Content Storage 13 are managed by the Program Manager component of the File Server 12, which is responsible for transmitting the files between the Content Storage 13 system and the Producer 30. The Program Manager is also responsible for deleting Program files at the request of the Producer 30.

An example embodiment of the present invention includes content prepared for streaming or broadband communication links at 128 kbps and above, multiplexing:

Images (for example, minimum 1 VGA frame per 5 seconds)

Text

Speech (for example, G.729)

This may be accomplished, for example, using conventional data compression and formatting schemes (including MPEG, JPEG and others).

In another example of the present invention, an authoring tool in the Producer 30 allows content providers to control content presentation by providing formatting commands for content providers in the following categories:

Image transition (appear, wipe vertical/horizontal)

Text (formatting, font type, size)

Emphasis (bold, italic, underlined, blinking)

Color

Manipulation (scroll; vertical, horizontal)

Horizontal Position
Adjustment (left, center, right, justified)
Margin (left offset, right offset)

Vertical Position
Adjustment (top, center, bottom
Margin (top offset, bottom offset)

Content may be distributed using two distinct modes of distributing content:

On-Demand—When the user joins, the content begins at the beginning of the program and is synchronized with the user session. The content is pre-recorded and stored by the Server 11. An example of this type of distribution might be a newspaper channel, a specialty channel, a shopping channel, etc.

Live Content (Generated Live)—The content is generated on-the-fly by the Producer 30, delivered to Server 11 over fast link connections and then relayed to Players 20. The user joins the stream whenever he/she selects the channel that is already underway (for example, news channels).

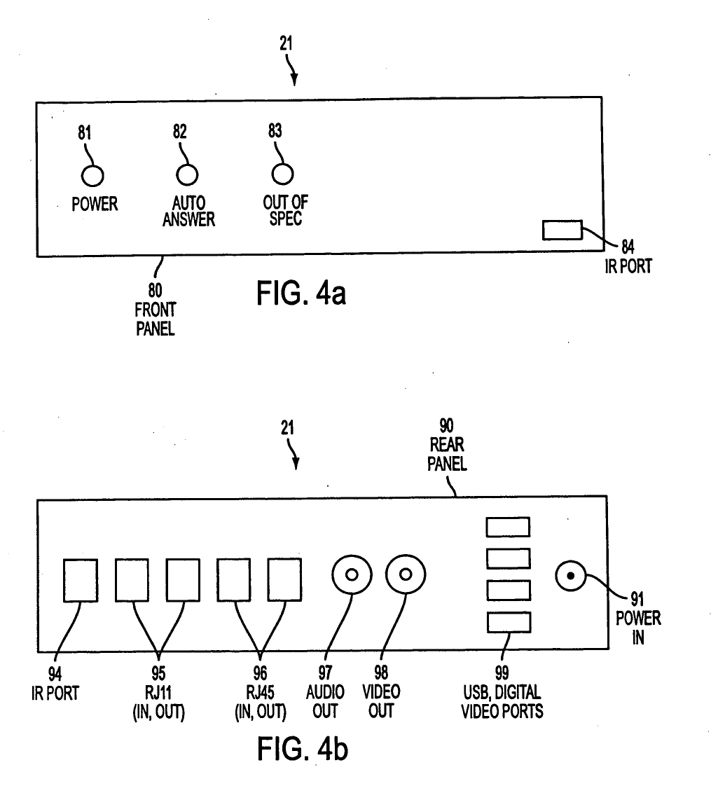

The TVGATE 21 may be connected to a TV over a video cable with RCS connector and two audio channels: stereo right and stereo left. An example of the physical interfaces that may be included in the TVGATE 21 is provided in FIGS. 4a, b.

FIG. 4a illustrates a front panel 80 of TVGATE 21. Front panel 80 houses an indicator lamp 81 to indicate that power is applied to TVGATE 21, an auto answer lamp 82 to indicate that an auto answer feature is selected for inbound communications, and an out of specification lamp 83 to indicate when a self-diagnostic indicates fault discovered within TVGATE 21. In addition, front panel 90 includes an IR port 84 for communicating with remote control 50 of FIG. 3.

FIG. 45 illustrates a rear panel 90 of TVGATE 21. Rear panel 90 houses 1R port for communicating with remote control 50, RJ11 interfaces 95 for conununicating with the PSTN, and RJ45 interfaces 96 for communicating with a cable modem or other network connections. Rear panel 90 also includes audio out port 97 and video out port 98 for providing audio and video signals to a display device, other interfaces 90, and power in port 91.

Connectivity with the Backend Network may be effectively achieved through a DSL/Cable connection. Dialup, wireless and satellite connections may alternatively be provided. Content distribution may also be provided, for example, over the Internet via Internet Services Providers (ISPs). This will be an effective approach for program content to be broadcast to a multiplicity of Players.

End-user access connection and configuration information may optionally be stored, for example, in flash RAM in the TVGATE 21, so that when the unit is restarted, it can reconnect using the same method.

In a preferred embodiment, when the TVGATE 21t is powered up, it immediately attempts to reconnect to the server using the same method used the last time it was connected. If the system falls to connect, or if this is the first time the TVGATE 21 is trying to connect, it may optionally reconnect on a Toll-Free telephone line, using an internal modem in the TVGATE 21. At this point, the user may select the Setup function 71 as illustrated in FIG. 2, and choose to reconnect the TVGATE 21 to the network using a different dial-up line or digital connection (like DSLICABLE). The TVGATE 21 can be configured to automatically reconnect via a local ISP which is contracted to serve as an alternate service provider for providing this service, to minimize use of Toll-Free numbers and the associated modem pool that will be required for this purpose.

An infrared Universal Remote Control (URC) may be selected as the primary control for the system, enabling the user to replace the control easily when necessary. Alternatively, a specialized remote control 50 can be provided (see, for example, FIG. 3).

The TVGATE 21 may be pre-programmed as necessary to accept the URC commands.

A backend data center will typically host the streaming servers. Continuous streaming may present the network with tremendous workload.

Multiple servers may be used to manage content and bandwidth. Modem pools are necessary at the server for the Toll-Free number handling. As previously mentioned, users will be able to connect for broadband features, for example, through ISP backbone networks employing secure VPN technology.

Upon purchase of a TVGATE 21 appliance, the purchaser may request assignment of an identifying name and/or number. The name and/or number will be securely stored in the TVGATE appliance to identify the appliance. This information may be stored at the time of manufacture of the unit, together with a PIN number. Alternatively, the information and PIN number may be remotely programmed into the unit in a secure manner (for example, using an encrypted wireless transmission). This information may be used, for example, as authentication information for the purposes of VPN communications.

At the same time and in the same manner, the TVGATE 21 may be programmed to securely contain shipping address, telephone and credit card information for the user. This information may be automatically and securely transmitted by the TVGATE 21, for example, in conjunction with customer service request and digital wallet features as they may be invoked by users.

The present invention is realized by a complex system of interoperating components, each of which is responsible for a small, discrete portion of functionality. The Server 10 componentized such that the performance-intensive streaming functionality is separated from the more variable Program Creating & Editing functionality. In this way, the different machines and software can be fine-tuned for their specific responsibilities. The Player 20, which resides on the TVGATE 21, may allow static image data caching, and include functionality for automatically connecting to the Streaming Server 11. The Producer 30 is will allow Content Providers and Channel Producers to send to Server 10 pre-formatted content, enabling the provider to prepare programming for their Channel.

The foregoing describes the invention in terms of embodiments foreseen by the inventor for which an enabling description was available, notwithstanding that insubstantial modifications of the invention, not presently foreseen, may nonetheless represent equivalents thereto.

I claim:

1. A system for distributing program content to one or more display devices on a subscription basis, the system comprising:
(a) a server for receiving authored program content for storing the received content, for scheduling playback of stored content at one or more predetermined times, and for delivering the stored content to one or more subscribers over at least one broadband network at the one or more predetermined times, and
(b) a Player for initiating a subscription for delivery of the stored content, for receiving the stored content over the at least one broadband network, and for providing the stored content to a display device for display.

2. The system of claim 1, further comprising: (c) a producer for authoring stored content and providing the authored content to the server in a predetermined format.

3. The system of claim 2, wherein the predetermined format includes information identifying the one or more predetermined times.

4. A player for providing broadcast information for display by a display device, the player comprising:
(a) setup means for connecting and logging in to a network for receiving broadcast information;
(b) menu means for causing one or more broadcast channels to be identified on the display device;
(c) selection means for selecting a broadcast channel to which the player is subscribed; and
(d) interaction means for selecting a feature identified by the broadcast information.
